(19) United States
(12) Patent Application Publication
(10) Pub. No.: US 2020/0176981 A1
(43) Pub. Date: Jun. 4, 2020

(54) ESD PROTECTION CIRCUIT

(71) Applicant: Qorvo US, Inc., Greensboro, NC (US)

(72) Inventor: Kathleen Muhonen, Greensboro, NC (US)

(21) Appl. No.: 16/782,219

(22) Filed: Feb. 5, 2020

Related U.S. Application Data
(63) Continuation of application No. 14/271,899, filed on May 7, 2014.
(60) Provisional application No. 61/820,325, filed on May 7, 2013.

(51) Int. Cl. H02H 9/04

(52) U.S. Cl. CPC H02H 9/046

(57) ABSTRACT

Embodiments of electrostatic discharge (ESD) protection circuits are disclosed along with methods of providing ESD protection. In one embodiment, an ESD protection circuit includes a first ESD protection clamp and a second ESD protection clamp operably associated in a dual-polarity ESD protection configuration. The first ESD protection clamp includes a trigger path and a clamped ESD protection path. The first ESD protection clamp is configured to trigger the clamped ESD protection path in response to an input voltage reaching a trigger voltage level. The second ESD protection clamp breaks down in response to the input voltage reaching a clamp breakdown voltage level that has a magnitude equal to or greater than the trigger voltage level. Since the clamp breakdown voltage level is equal to or greater than the trigger voltage level provided by the first ESD protection clamp, the ESD protection circuit can provide better ESD protection performance ratings.

### RELATED APPLICATION

This application is a continuation of U.S. patent application Ser. No. 14/271,899, filed on May 7, 2014, which claims the benefit of provisional patent application No. 61/820,325, filed May 7, 2013, the disclosures of which are hereby incorporated herein by reference in their entireties.

### FIELD OF THE DISCLOSURE

This disclosure relates generally to electrostatic discharge (ESD) protection circuits and methods of providing ESD protection.

### BACKGROUND

As integrated circuits (ICs) become increasingly miniaturized and compact, electrostatic discharge (ESD) is one of the most important reliability problems in IC design. Electrostatic discharge (ESD) is the sudden release of electrostatic charge. ESD is caused by the buildup of electrostatic charge in an IC. For example, electrostatic charge can build up in the IC as a result of static electricity, external and internal electromagnetic fields, and/or the like. As electrostatic charge builds up in the IC, electrostatic voltages in the IC increase. If these electrostatic voltages are too high, the IC may be damaged when ESD occurs as the release of the electrostatic charge can result in high electric fields and currents within the IC. Up to 70% of IC failures are caused by ESD.

ESD protection circuits are often used in ICs in order to protect ICs from ESD. More specifically, ESD protection circuits are used to release the electrostatic charge before the electrostatic voltages become too high. Since ESD events can result from both positive and negative electrostatic voltages, it is desirable that an ESD protection circuit protect the IC from both positive and negative ESD events. While ESD protection circuits capable of protecting against both positive and negative ESD events are known, these ESD protection circuits often suffer from breakdown problems. As such, ESD protection performance ratings (e.g., a Human Body Model (HBM) rating) for these ESD protection circuits can be significantly degraded.

Accordingly, ESD protection circuits are needed that are capable of protecting against both positive and negative ESD events while providing increased ESD protection performance ratings.

### SUMMARY

Embodiments of electrostatic discharge (ESD) protection circuits are disclosed along with methods of providing ESD protection. In one embodiment, an ESD protection circuit includes a first ESD protection clamp and a second ESD protection clamp. The first ESD protection clamp and the second ESD protection clamp are operably associated such that the first ESD protection clamp and the second ESD protection clamp are in a dual-polarity ESD protection configuration. Consequently, the ESD protection circuit protects against both positive and negative ESD events. The first ESD protection clamp includes a first trigger path and a first clamped ESD protection path. The first trigger path is configured to be biased by an input voltage and the first clamped ESD protection path is operably associated with the first trigger path. To provide protection against an ESD event of a first voltage polarity (e.g., a positive voltage polarity), the first ESD protection clamp is configured to trigger the first clamped ESD protection path in response to the input voltage that biases the first trigger path reaching a first trigger voltage level. The first trigger voltage level is defined by the first voltage polarity (e.g., the positive voltage polarity) and a first voltage magnitude.

The second ESD protection clamp provides protection against an ESD event of a second voltage polarity (e.g., a negative voltage polarity) opposite to the first voltage polarity. The second ESD protection clamp is operable to break down in response to the input voltage that biases the first trigger path reaching a first clamp breakdown voltage level defined by the first voltage polarity (e.g., a positive voltage polarity) and a second voltage magnitude equal to or greater than the first voltage magnitude. Since the second voltage magnitude of the first clamp breakdown voltage level is equal to or greater than the first voltage magnitude of the first trigger voltage level provided by the first ESD protection clamp, the second ESD protection clamp does not break down due to electrostatic charge of the first voltage polarity (e.g., the positive voltage polarity) before the first ESD protection clamp is triggered. As a result, the ESD protection circuit can provide better ESD protection performance ratings.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates an exemplary electrostatic discharge (ESD) protection circuit having a first ESD protection clamp and a second ESD protection clamp operably associated in a dual-polarity ESD protection configuration, wherein the first ESD protection clamp and the second ESD protection clamp each use a transistor as a clamping device.

FIG. 2 illustrates another embodiment of the ESD protection circuit, which is similar to the embodiment shown in FIG. 1 except that the first ESD protection clamp and the second ESD protection clamp each use a Darlington pair as a clamping device.

FIG. 3 illustrates another embodiment of the ESD protection circuit, which is similar to the embodiment shown in FIG. 2 except that the first ESD protection clamp and the second ESD protection clamp each include a trigger tuning path.

FIG. 4 illustrates an example of the ESD protection circuit shown in FIG. 2.

FIG. 5 is a graph that illustrates data obtained by performing Transmission Line Pulsing (TLP) testing on the ESD protection circuit shown in FIG. 4.

FIG. 6 illustrates another example of the embodiment of the ESD protection circuit shown in FIG. 2.

FIG. 7 is a graph that illustrates data obtained by performing TLP testing on the ESD protection circuit shown in FIG. 6.

FIG. 8 is an example of the ESD protection circuit shown in FIG. 3.

FIG. 9 is a graph that illustrates data obtained by performing TLP testing on the ESD protection circuit shown in FIG. 8.

FIG. 10 is another example of the ESD protection circuit shown in FIG. 3.

FIG. 11 is a graph that illustrates data obtained by performing TLP testing on the ESD protection circuit shown in FIG. 10.

FIG. 12 is still another example of the ESD protection circuit shown in FIG. 2.

FIG. 13 illustrates an exemplary physical layout of the ESD protection circuit shown in FIG. 12.

FIG. 14 illustrates a graph that describes a Carrier to Composite Noise Ratio (CCN) of a Cable Television (CATV) amplifier having a node protected by the ESD protection circuit shown in FIGS. 12 and 13.

FIG. 15 illustrates a graph that describes a noise figure of the CATV amplifier having the node protected by the ESD protection circuit shown in FIGS. 12 and 13.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It should further be noted that throughout the disclosure, relational terminology, such as “greater,” “less,” “above,” “below,” “larger,” “smaller,” and/or the like, is used when describing relationships between voltages and voltage levels. This relational terminology is describing relationships between the voltage magnitudes of the voltage levels irrespective of a sign convention used to describe voltage polarities of the voltage levels of the voltages. Thus, when relational terminology such as “greater,” “less,” “above,” “below,” “larger,” and/or “smaller” is used to describe a relationship between two voltage levels, the relational terminology is referring to a relationship between voltage magnitudes of the two voltage levels. For example, a first voltage having a first voltage level of +10V is considered to be greater than a second voltage having a second voltage level of +1V. However, if the first voltage level has the first voltage level of −10V, the first voltage level is also considered to be greater than the second voltage level of the second voltage if the second voltage level is −1V. More specifically, the relational term “greater” is referring to a magnitude of the first voltage level being greater than a magnitude of the second voltage level.

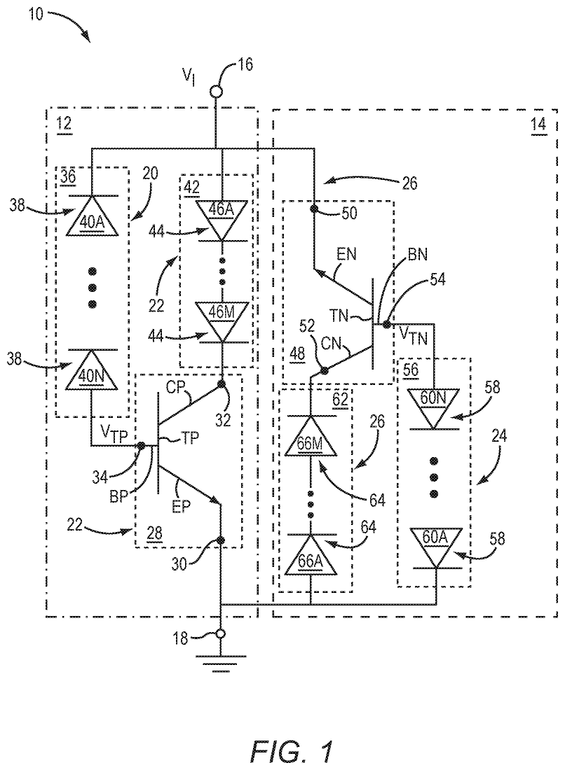

Referring now to FIG. 1, FIG. 1 illustrates an exemplary electrostatic discharge (ESD) protection circuit 10. The ESD protection circuit 10 includes a first ESD protection clamp 12 and a second ESD protection clamp 14 operably associated with the first ESD protection clamp 12. The first ESD protection clamp 12 and the second ESD protection clamp 14 are in a dual-polarity ESD protection configuration. Accordingly, the ESD protection circuit 10 is configured to protect against both positive ESD events and negative ESD events. In this embodiment, the first ESD protection clamp 12 is a positive ESD protection clamp since the first ESD protection clamp 12 protects against positive ESD events. Additionally, the second ESD protection clamp 14 is a negative ESD protection clamp since the second ESD protection clamp 14 protects against negative ESD events.

As shown in FIG. 1, the first ESD protection clamp 12 and the second ESD protection clamp 14 are both connected between an input terminal 16 and an output terminal 18. The input terminal 16 may be connected to sensitive nodes within an integrated circuit (IC). For example, the IC may include a radio frequency (RF) circuit where the input terminal 16 is connected to a node within the RF circuit so that the ESD protection circuit 10 provides ESD protection to the RF circuit. The input terminal 16 is operable to receive an input voltage V_{I}, which may be a voltage provided at a protected node of the IC. In this embodiment, the output terminal 18 is grounded. The input voltage V_{I} increases as electrostatic charge builds up at the node.

The first ESD protection clamp 12 is provided to protect the node from positive ESD events. For example, the input voltage V_{I} may have a first voltage polarity, which for the sake of explanation is assumed to be a positive voltage polarity. As positive electrostatic charge builds up at the protected node connected to the input terminal 16, the input voltage V_{I} at the input terminal 16 increases and is provided with the positive voltage polarity. When the input voltage V_{I} is below a first trigger voltage level, the first ESD protection clamp 12 is configured to be open such that the first ESD protection clamp 12 presents a very high (theoretically infinite) resistance between the input terminal 16 and the output terminal 18. The first trigger voltage level is a voltage level at which the first ESD protection clamp 12 is configured to be triggered, and thus is a positive trigger voltage level. As such, the positive trigger voltage level is defined by the positive voltage polarity and a first voltage magnitude. Thus, once the input voltage V_{I} reaches the positive trigger voltage level, the first ESD protection clamp 12 is triggered and the positive electrostatic charge that has built up at the protected node is transmitted to the output terminal 18. Since the output terminal 18 shown in FIG. 1 is grounded, the positive electrostatic charge is grounded when the first ESD protection clamp 12 is triggered. In this manner, the first ESD protection clamp 12 protects the protected node from positive ESD events, because the first ESD protection clamp 12 helps to prevent positive electrostatic charge from reaching levels that may damage the IC.

The input voltage V_{I} may also have a second voltage polarity antipodal to the first voltage polarity. For the sake of explanation, the second voltage polarity is assumed to be a negative voltage polarity. The second ESD protection clamp 14 is provided to protect the node connected to the input terminal 16 from negative ESD events. Thus, the second ESD protection clamp 14 remains open while the input voltage V_{I} has the positive voltage polarity. However, as negative electrostatic charge builds up at the protected node connected to the input terminal 16, the input voltage V_{I} at the input terminal 16 increases and is provided with the negative voltage polarity. While the input voltage V_{I} is smaller than a second trigger voltage level, the second ESD protection clamp 14 is configured to be open such that the second ESD protection clamp 14 presents a very high (theoretically infinite) resistance between the input terminal 16 and the output terminal 18. The second trigger voltage level is a voltage level at which the second ESD protection clamp 14 is configured to be triggered, and thus is a negative trigger voltage level. As such, the negative trigger voltage level is defined by the negative voltage polarity and a second voltage magnitude. Thus, once the input voltage V_{I} reaches the negative trigger voltage level, the second ESD protection clamp 14 is triggered and the negative electrostatic charge that has built up at the protected node is transmitted to the output terminal 18. Since the output terminal 18 shown in FIG. 1 is grounded, the negative electrostatic charge is grounded when the second ESD protection clamp 14 is triggered. In this manner, the second ESD protection clamp 14 protects the protected node from negative ESD events, because the second ESD protection clamp 14 helps to prevent negative positive electrostatic charge from reaching levels that may damage the IC. Since the first ESD protection clamp 12 protects against positive ESD events, the second ESD protection clamp 14 remains open while the input voltage V_{I} has the positive voltage polarity.

The first ESD protection clamp 12 and the second ESD protection clamp 14 shown in FIG. 1 are symmetrical. Thus, the first ESD protection clamp 12 and the second ESD protection clamp 14 are configured to be identical and have essentially the same operational characteristics but operate with respect to different voltage polarities. Accordingly, in this embodiment, the first voltage magnitude of the positive trigger voltage level is substantially equal to the second voltage magnitude of the negative trigger voltage level. In this manner, the first ESD protection clamp 12 and the second ESD protection clamp 14 are triggered when the input voltage V_{I} has the same voltage magnitude having the different voltage polarities (i.e., the positive voltage polarity with respect to the first ESD protection clamp 12 and the negative voltage polarity with respect to the second ESD protection clamp 14). In alternative embodiments, the first voltage magnitude of the positive trigger voltage level and the second voltage magnitude of the negative trigger voltage level may be substantially different.

As shown in FIG. 1, the first ESD protection clamp 12 includes a trigger path 20 and a clamped ESD protection path 22, while the second ESD protection clamp 14 includes a trigger path 24 and a clamped ESD protection path 26. The trigger path 20 of the first ESD protection clamp 12 is configured to be biased by the input voltage V_{I}. The clamped ESD protection path 22 is operably associated with the trigger path 20 such that the trigger path 20 is used to trigger the clamped ESD protection path 22. In this embodiment, the ESD protection circuit 10 includes a clamping device 28 (also referred to as “a first clamping device” hereinafter) operably associated with the trigger path 20. The clamping device 28 is configured to clamp the clamped ESD protection path 22. As shown in FIG. 1, the clamping device 28 is coupled within the clamped ESD protection path 22. In this embodiment, the clamping device 28 is a transistor TP (also referred to as “a first transistor” hereinafter), which in this embodiment is a bipolar junction transistor (BJT). Thus, the transistor TP includes a base BP, an emitter EP, and a collector CP. However, other types of clamping devices may also be used, such as field effect transistors, Darlington pairs, stacks of transistors, networks of transistors, and/or the like.

The first ESD protection clamp 12 is configured to trigger the clamped ESD protection path 22 in response to the input voltage V_{I} that biases the trigger path 20 reaching the positive trigger voltage level. In this embodiment, the clamping device 28 in the clamped ESD protection path 22 has an inverting terminal 30 (also referred to as “a first inverting terminal” hereinafter), a non-inverting terminal 32 (also referred to as “a first non-inverting terminal” hereinafter), and a control terminal 34 (also referred to as “a first control terminal” hereinafter). The first trigger voltage level is defined by the first voltage polarity (e.g., the positive voltage polarity) and a first voltage magnitude. Thus, the first ESD protection clamp 12 is triggered whenever the input voltage V_{I} has the first voltage polarity and is greater than or equal to the first voltage magnitude. As such, the first ESD protection clamp 12 is triggered by an ESD event of the first voltage polarity.

Since the clamping device 28 clamps the clamped ESD protection path 22, the clamped ESD protection path 22 is triggered as a result of the clamping device 28 being triggered. More specifically, the clamping device 28 is configured to trigger in response to the input voltage V_{I} that biases the trigger path 20 reaching the first trigger voltage level. The clamping device 28 is configured to set the first voltage magnitude of the first ESD protection clamp 12. The clamping device 28 is also configured to trigger in response to the input voltage V_{I} that biases the trigger path 20 reaching the first trigger voltage level such that the clamped ESD protection path 22 is triggered as a result of the clamping device 28 being triggered.

In this example, the inverting terminal 30 is connected to the emitter EP of the transistor TP, the non-inverting terminal 32 is connected to the collector CP of the transistor TP, and the control terminal 34 is connected to the base BP of the transistor TP. As shown in FIG. 1, the inverting terminal 30 and the non-inverting terminal 32 are both connected within the clamped ESD protection path 22. In this manner, the clamping device 28 is configured to clamp the clamped ESD protection path 22. Also, the control terminal 34 is connected to the trigger path 20. As such, the trigger path 20 of the first ESD protection clamp 12 is connected between the input terminal 16 and the control terminal 34. Consequently, the input voltage V_{I} biases the trigger path 20. In this embodiment, the clamped ESD protection path 22 is connected between the input terminal 16 and the output terminal 18. Thus, while the clamped ESD protection path 22 is open, the input voltage V_{I} is dropped across the clamped ESD protection path 22. Once the clamped ESD protection path 22 is triggered, the clamped ESD protection path 22 shunts the input voltage V_{I} to ground.

The first ESD protection clamp 12 is configured to trigger the clamped ESD protection path 22 in response to the input voltage V_{I} that biases the trigger path 20 reaching the positive trigger voltage level. Thus, the clamped ESD protection path 22 of the first ESD protection clamp 12 is triggered whenever the input voltage V_{I} has the positive voltage polarity and is greater than or equal to the first voltage magnitude. As such, the first ESD protection clamp 12 protects against positive ESD events. Since the clamping device 28 clamps the clamped ESD protection path 22, the clamped ESD protection path 22 is triggered as a result of the clamping device 28 being triggered. More specifically, the clamping device 28 is configured to trigger in response to the input voltage V_{I} that biases the trigger path 20 reaching the positive trigger voltage level.

The first voltage magnitude of the positive trigger voltage level is thus set by operational characteristics of the clamping device 28 and the trigger path 20. More specifically, the clamping device 28 is configured to have a clamping device trigger voltage level having the positive voltage polarity. With regard to the clamping device 28 shown in FIG. 1, the clamping device trigger voltage level is determined by a threshold voltage level between the base BP and the emitter EP of the transistor TP. So as to improve a maximum positive voltage rating of the ESD protection circuit 10, the trigger path 20 is configured to set the first voltage magnitude of the positive trigger voltage level above a voltage magnitude of the clamping device trigger voltage level (e.g., the threshold voltage level of the transistor TP). In this embodiment, the trigger path 20 of the first ESD protection clamp 12 includes a stack 36 (also referred to as “a first trigger stack” hereinafter) of diode-configured semiconductor devices 38. The stack 36 shown in FIG. 1 includes N number of diode-configured semiconductor devices 38, where N is an integer greater or equal to one. The diode-configured semiconductor devices 38 may be each be any type of semiconductor device capable of providing a diode-type operation. For example, the diode-configured semiconductor devices 38 may be diodes, varactors, transistors in a diode configuration, silicon rectifiers, and/or the like. In this embodiment, the diode-configured semiconductor devices 38 are diodes 40A-40N (also referred to as “first trigger diodes” hereinafter). Each of the diodes 40A-40N is stacked within the trigger path 20.

The first ESD protection clamp 12 is configured to trigger in response to the input voltage V_{I} that biases the trigger path 20 reaching the positive trigger voltage level such that the clamped ESD protection path 22 is triggered as a result of the clamping device 28 being triggered. Since the control terminal 34 is connected to the trigger path 20, the trigger path 20 provides a control voltage V_{TP} at the control terminal 34 of the clamping device 28 in response to the input voltage V_{I} biasing the trigger path 20. When the control voltage V_{TP} reaches the clamping device trigger voltage level, a voltage between the base BP and the emitter EP is equal to or greater than a threshold voltage level of the transistor TP. As such, the clamping device 28 is triggered. Note, however, that there is a voltage drop across the stack 36 of diode-configured semiconductor devices 38. With respect to the positive voltage polarity, the voltage across the stack 36 of diode-configured semiconductor devices 38 has to reach a stack breakdown voltage magnitude in order for current to flow through the trigger path 20. Accordingly, the stack 36 of diode-configured semiconductor devices 38 in the trigger path 20 of the first ESD protection clamp 12 increases the first voltage magnitude of the positive trigger voltage level above the voltage magnitude of the clamping device trigger voltage level because the voltage across the stack 36 of diode-configured semiconductor devices 38 has to be at least at the stack breakdown voltage magnitude before the control voltage V_{TP} at the control terminal 34 reaches the clamping device trigger voltage level.

In this embodiment, each of the diodes 40A-40N is a Schottky diode and is coupled in the trigger path 20 so as to be reverse biased when the input voltage V_{I} at the input terminal 16 has the positive voltage polarity, and forward biased when the input voltage V_{I} at the input terminal 16 has the negative voltage polarity. Thus, the input voltage V_{I} at the input terminal 16 has to be high enough to cause each of the diodes 40A-40N to avalanche before the control voltage V_{TP} at the control terminal 34 can reach the clamping device trigger voltage level. The trigger path 20 is thus configured to increase the first voltage magnitude of the positive trigger voltage level so that the first voltage magnitude is greater than the clamping device trigger voltage level of the clamping device 28. While the diodes 40A-40N shown in FIG. 1 are Schottky diodes, any suitable type of diode may be used. Furthermore, in alternative embodiments, one or more of the diodes 40A-40N may be forward biased with respect to the positive voltage polarity and reverse biased with respect to the negative voltage polarity. Accordingly, the stack 36 of diode-configured semiconductor devices 38 is configured to set the first voltage magnitude of the positive trigger voltage level above the clamping device trigger voltage level.

The first ESD protection clamp 12 (i.e., the positive ESD protection clamp) is operable to break down in response to the input voltage V_{I} that biases the trigger path 20 reaching a first clamp breakdown voltage level, which in this embodiment is a negative clamp breakdown voltage level. In order to not degrade a maximum negative voltage rating of the ESD protection circuit 10, the clamped ESD protection path 22 should be maintained open while the input voltage V_{I} has the negative voltage polarity. Otherwise, if the clamped ESD protection path 22 (i.e., the positive ESD protection path) in the first ESD protection clamp 12 (i.e., the positive ESD protection clamp) breaks down before the clamped ESD protection path 26 (i.e., the negative ESD protection path) in the second ESD protection clamp 14 (i.e., the negative ESD protection clamp) is triggered, the maximum negative voltage rating of the ESD protection circuit 10 is decreased. Accordingly, the negative clamp breakdown voltage level of the clamped ESD protection path 22 (i.e., the positive ESD protection path) is defined by the negative voltage polarity and a third voltage magnitude equal to or greater than the second voltage magnitude of the negative trigger voltage level provided by the clamped ESD protection path 26 (i.e., the negative ESD protection path). The third voltage magnitude of the negative clamp breakdown voltage level is thus at least equal to (but can also be provided greater than) the second voltage magnitude of the negative trigger voltage level. In this manner, while the input voltage V_{I} has the negative voltage polarity, the clamped ESD protection path 22 (i.e., the positive ESD protection path) in the first ESD protection clamp 12 (i.e., the positive ESD protection clamp) does not break down before the clamped ESD protection path 26 (i.e., the negative ESD protection path) in the second ESD protection clamp 14 (i.e., the negative ESD protection clamp) is triggered. This maintains the maximum negative voltage rating of the ESD protection circuit 10.

Nevertheless, in this embodiment, the clamping device 28 (i.e., the positive clamping device) has a clamping device breakdown voltage level with a voltage magnitude that is less than the second voltage magnitude of the negative trigger voltage level of the second ESD protection clamp 14 (i.e., the negative clamping device). It should also be noted that the second ESD protection clamp 14 may also break down after the first ESD protection clamp 12 has been triggered and cause the ESD protection circuit 10 to fail. As such, the transistor TP in the clamped ESD protection path 22 (i.e., the positive ESD protection path) may break down when a negative voltage across the base BP and the emitter EP reaches the clamping device breakdown voltage level. Thus, in order to prevent the clamping device 28 (i.e., the positive clamping device) from breaking down before or while the clamped ESD protection path 26 (i.e., the negative ESD protection path) in the second ESD protection clamp 14 (i.e., the negative ESD protection clamp) is triggered, the clamped ESD protection path 22 is configured to increase the third voltage magnitude of the negative clamp breakdown voltage level such that the third voltage magnitude is greater than the voltage magnitude of the clamping device breakdown voltage level provided by the clamping device 28 (i.e., the positive clamping device). More specifically, the clamped ESD protection path 22 includes a stack 42 (also referred to as “a first protection stack” hereinafter) of diode-configured semiconductor devices 44. The stack 42 shown in FIG. 1 includes M number of diode-configured semiconductor devices 44, where M is an integer greater than or equal to one. The diode-configured semiconductor devices 44 may each be any type of semiconductor device capable of providing a diode-type operation. For example, the diode-configured semiconductor devices 44 may be diodes, varactors, transistors in a diode configuration, silicon rectifiers, and/or the like. In this embodiment, the diode-configured semiconductor devices 44 are diodes 46A-46M (also referred to as “first protection diodes” hereinafter). Each of the diodes 46A-46M is stacked within the clamped ESD protection path 22.

Since the stack 42 of the diode-configured semiconductor devices 44 shown in FIG. 1 is connected between the input terminal 16 and the non-inverting terminal 32 of the clamping device 28, the input voltage V_{I} biases the stack 42 of the diode-configured semiconductor devices 44. As such, there is a voltage drop across the stack 42 of the diode-configured semiconductor devices 44. With respect to the negative voltage polarity of the input voltage V_{I}, the voltage across the stack 42 of the diode-configured semiconductor devices 44 has to reach a stack breakdown voltage magnitude in order for current to flow through the clamped ESD protection path 22. In this embodiment, when the input voltage V_{I} reaches the negative clamp breakdown voltage level, a voltage between the base BP and the emitter EP of the transistor TP reaches the clamping device breakdown voltage level provided by the clamping device 28 (i.e., the positive clamping device). Accordingly, the clamping device 28 and the clamped ESD protection path 22 break down. However, with respect to the negative voltage polarity, the voltage across the stack 42 of the diode-configured semiconductor devices 44 has to reach the stack breakdown voltage magnitude before the clamping device 28 breaks down. Accordingly, the stack 42 of the diode-configured semiconductor devices 44 in the clamped ESD protection path 22 of the first ESD protection clamp 12 increases the third voltage magnitude of the negative clamp breakdown voltage level so that the third voltage magnitude is greater than the second voltage magnitude of the negative trigger voltage level of the second ESD protection clamp 14. Additionally, the stack 42 of the diode-configured semiconductor devices 44 in the clamped ESD protection path 22 of the first ESD protection clamp 12 increases the third voltage magnitude of the negative clamp breakdown voltage level is greater than the negative trigger voltage level provided by the second ESD protection clamp 14. As such, the stack 42 of the diode-configured semiconductor devices 44 prevents the clamped ESD protection path 22 (i.e., the positive ESD protection path) of the first ESD protection clamp 12 (i.e., the positive ESD protection clamp) from breaking down before the clamped ESD protection path 26 (i.e., the negative ESD protection path) of the second ESD protection clamp 14 (i.e., the negative ESD protection clamp) is triggered. As such, the stack 42 of the diode-configured semiconductor devices 44 increases the maximum negative voltage rating of the ESD protection circuit 10.

In this embodiment, each of the diodes 46A-46M is a diode-configured BJT and is coupled in the clamped ESD protection path 22 so as to be forward biased when the input voltage V_{I} at the input terminal 16 has the positive voltage polarity, and reverse biased when the input voltage V_{I} at the input terminal 16 has the negative voltage polarity. Thus, in order for the clamping device 28 to break down, the input voltage V_{I} at the input terminal 16 has to be high enough with a negative voltage polarity to cause each of the diodes 46A-46M to avalanche. While the diodes 46A-46M shown in FIG. 1 are diode-configured BJTs, any suitable type of diode may be used. Furthermore, in alternative embodiments, one or more of the diodes 46A-46M may be reverse biased with respect to the positive voltage polarity and forward biased with respect to the negative voltage polarity. Accordingly, the stack 42 of the diode-configured semiconductor devices 44 is configured to increase the third voltage magnitude of the negative clamp breakdown voltage level above the trigger voltage level of the clamping second ESD protection clamp 14.

With respect to the second ESD protection clamp 14, the trigger path 24 of the second ESD protection clamp 14 is configured to be biased by the input voltage V_{I}. The clamped ESD protection path 26 is operably associated with the trigger path 24 such that the trigger path 24 is used to trigger the clamped ESD protection path 26. In this embodiment, the ESD protection circuit 10 includes a clamping device 48 (also referred to as “a second clamping device” hereinafter) operably associated with the trigger path 24. The clamping device 48 is configured to clamp the clamped ESD protection path 26. As shown in FIG. 1, the clamping device 48 is coupled within the clamped ESD protection path 26. In this embodiment, the clamping device 48 is a transistor TN (also referred to as “a second transistor” hereinafter), which in this embodiment is a BJT. Thus, the transistor TN includes a base BN, an emitter EN, and a collector CN. However, other types of clamping devices may also be used, such as field effect transistors, Darlington pairs, stacks of transistors, networks of transistors, and/or the like.

The second ESD protection clamp 14 is configured to trigger the clamped ESD protection path 26 in response to the input voltage V_{I} that biases the trigger path 24 reaching the negative trigger voltage level. In this embodiment, the clamping device 48 in the clamped ESD protection path 26 has an inverting terminal 50 (also referred to as “a second inverting terminal” hereinafter), a non-inverting terminal 52 (also referred to as “a second non-inverting terminal” hereinafter), and a control terminal 54 (also referred to as “a second control terminal” hereinafter). The second ESD protection clamp 14 is triggered whenever the input voltage V_{I} has the negative voltage polarity and is greater than or equal to the second voltage magnitude. As such, the second ESD protection clamp 14 is triggered by an ESD event of the negative voltage polarity.

Since the clamping device 48 clamps the clamped ESD protection path 26, the clamped ESD protection path 26 is triggered as a result of the clamping device 48 being triggered. More specifically, the clamping device 48 is configured to trigger in response to the input voltage V_{I} that biases the trigger path 24 reaching the negative trigger voltage level. As such, the clamped ESD protection path 26 is configured to trigger in response to the input voltage V_{I} that biases the trigger path 24 reaching the negative trigger voltage level, such that the clamped ESD protection path 26 is triggered as a result of the clamping device 48 being triggered.

The trigger path 24 is configured to set the second voltage magnitude of the second ESD protection clamp 14. In this example, the inverting terminal 50 is connected to the emitter EN of the transistor TN, the non-inverting terminal 52 is connected to the collector CN of the transistor TN, and the control terminal 54 is connected to the base BN of the transistor TN. As shown in FIG. 1, the inverting terminal 50 and the non-inverting terminal 52 are both connected within the clamped ESD protection path 26. In this manner, the clamping device 48 is configured to clamp the clamped ESD protection path 26. Also, the control terminal 54 is connected to the trigger path 24. As such, the trigger path 24 of the second ESD protection clamp 14 is connected between the output terminal 18 and the control terminal 54. The inverting terminal 50 of the clamping device 48 is connected to the input terminal 16. Consequently, the input voltage V_{I} biases the trigger path 24. In this embodiment, the clamped ESD protection path 26 is connected between the input terminal 16 and the output terminal 18. Thus, while the clamped ESD protection path 26 is open, the input voltage V_{I} is dropped across the clamped ESD protection path 26. Once the clamped ESD protection path 26 is triggered, the clamped ESD protection path 26 shunts the input voltage V_{I} to ground.

The second ESD protection clamp 14 is configured to trigger the clamped ESD protection path 26 in response to the input voltage V_{I} that biases the trigger path 24 reaching the negative trigger voltage level. Thus, the clamped ESD protection path 26 of the second ESD protection clamp 14 is triggered whenever the input voltage V_{I} has the negative voltage polarity and is greater than or equal to the second voltage magnitude. As such, the second ESD protection clamp 14 protects against negative ESD events. Since the clamping device 48 clamps the clamped ESD protection path 26, the clamped ESD protection path 26 is triggered as a result of the clamping device 48 being triggered. More specifically, the clamping device 48 is configured to trigger in response to the input voltage V_{I} that biases the trigger path 24 reaching the negative trigger voltage level.

The second voltage magnitude of the negative trigger voltage level is thus set by operational characteristics of the clamping device 48 and the trigger path 24. More specifically, the clamping device 48 is configured to have a clamping device trigger voltage level having the negative voltage polarity. With regard to the clamping device 48 shown in FIG. 1, the clamping device trigger voltage level is determined by a threshold voltage level between the base BN and the emitter EN of the transistor TN. So as to improve the maximum negative voltage rating of the ESD protection circuit 10, the trigger path 24 is configured to set the second voltage magnitude of the negative trigger voltage level above a voltage magnitude of the clamping device trigger voltage level (e.g., the threshold voltage level of the transistor TN). In this embodiment, the trigger path 24 of the second ESD protection clamp 14 includes a stack 56 of diode-configured semiconductor devices 58.

As mentioned above, the first ESD protection clamp 12 and the second ESD protection clamp 14 are symmetrical and are operably associated such that the first ESD protection clamp 12 and the second ESD protection clamp 14 are in the dual-polarity ESD configuration. As explained in further detail below, components in the first ESD protection clamp 12 and the second ESD protection clamp 14 are identical except that the components are coupled in reverse with respect to the input terminal 16 and the output terminal 18.

As such, the stack 56 (also referred to as “a second trigger stack” hereinafter) shown in FIG. 1 includes N number of the diode-configured semiconductor devices 58, just like the N number of the diode-configured semiconductor devices 38 in the stack 36. The diode-configured semiconductor devices 58 may each be any type of semiconductor device capable of providing a diode-type operation. For example, the diode-configured semiconductor devices 58 may be diodes, varactors, transistors in a diode configuration, silicon rectifiers, and/or the like. In this embodiment, the diode-configured semiconductor devices 58 are diodes 60A-60N (also referred to as “second trigger diodes” hereinafter). Each of the diodes 60A-60N is stacked within the trigger path 24. Since the first ESD protection clamp 12 and the second ESD protection clamp 14 are symmetrical and in the dual-polarity ESD configuration, the second voltage magnitude of the negative trigger voltage level for triggering the second ESD protection clamp 14 (e.g., the negative ESD protection clamp) is substantially equal to the first voltage magnitude of the positive trigger voltage level for triggering the first ESD protection clamp 12 (e.g., the positive ESD protection clamp).

The second ESD protection clamp 14 is configured to trigger in response to the input voltage V_{I} that biases the trigger path 24 reaching the negative trigger voltage level such that the clamped ESD protection path 26 is triggered as a result of the clamping device 48 being triggered. Since the control terminal 54 is connected to the trigger path 24, the trigger path 24 provides a control voltage V_{TN} at the control terminal 54 of the clamping device 48 in response to the input voltage V_{I} biasing the trigger path 24. When the control voltage V_{TN} reaches the negative trigger voltage level, a voltage between the base BN and the emitter EN is equal to or greater than threshold voltage level of the transistor TN. As such, the clamping device 48 is triggered. Note, however, that there is a voltage drop across the stack 56 of the diode-configured semiconductor devices 58. With respect to the negative voltage polarity, the voltage across the stack 56 of the diode-configured semiconductor devices 58 has to reach a stack breakdown voltage magnitude in order for current to flow through the trigger path 24. Accordingly, the stack 56 of the diode-configured semiconductor devices 58 in the trigger path 24 of the second ESD protection clamp 14 increases the second voltage magnitude of the negative trigger voltage level above the voltage magnitude of the clamping device trigger voltage level because the voltage across the stack 56 of the diode-configured semiconductor devices 58 has to be at least at the stack breakdown voltage magnitude before the control voltage V_{TN} at the control terminal 54 reaches the clamping device trigger voltage level.

In this embodiment, each of the diodes 60A-60N is a Schottky diode and is coupled in the trigger path 24 so as to be reverse biased when the input voltage V_{I} at the input terminal 16 has the negative voltage polarity and forward biased when the input voltage V_{I} at the input terminal 16 has the positive voltage polarity. Thus, the input voltage V_{I} at the input terminal 16 has to be high enough to cause each of the diodes 60A-60N to avalanche before the control voltage V_{TN} at the control terminal 54 can reach the threshold voltage level of the clamping device 48. The trigger path 24 is thus configured to increase the second voltage magnitude of the negative trigger voltage level so that the second voltage magnitude is greater than the clamping device trigger voltage level of the clamping device 48.

While the diodes 60A-60N shown in FIG. 1 are Schottky diodes, any suitable type of diode may be used. Furthermore, in alternative embodiments, one or more of the diodes 60A-60N may be forward biased with respect to the negative voltage polarity and reverse biased with respect to the positive voltage polarity. Accordingly, the stack 56 of the diode-configured semiconductor devices 58 is configured to set the second voltage magnitude of the negative trigger voltage level above the clamping device trigger voltage level of the clamping device 48.

The second ESD protection clamp 14 (i.e., the negative ESD protection clamp) is operable to break down in response to the input voltage V_{I} that biases the trigger path 24 reaching a second clamp breakdown voltage level, which in this embodiment is a positive clamp breakdown voltage level. In order to not degrade the maximum positive voltage rating of the ESD protection circuit 10, the clamped ESD protection path 26 should be maintained open while the input voltage V_{I} has the positive voltage polarity. Otherwise, if the clamped ESD protection path 26 (i.e., the negative ESD protection path) in the second ESD protection clamp 14 (i.e., the negative ESD protection clamp) breaks down before the clamped ESD protection path 22 (i.e., the positive ESD protection path) in the first ESD protection clamp 12 (i.e., the positive ESD protection clamp) is triggered, the maximum positive voltage rating of the ESD protection circuit 10 is decreased.

Accordingly, the positive clamp breakdown voltage level of the clamped ESD protection path 26 (i.e., the negative ESD protection path) is defined by the positive voltage polarity and a fourth voltage magnitude equal to or greater than the first voltage magnitude of the positive trigger voltage level provided by the clamped ESD protection path 22 (i.e., the positive ESD protection path). The fourth voltage magnitude of the positive clamp breakdown voltage level provided by the second ESD protection clamp 14 (i.e., the negative ESD protection clamp) is thus at least equal to (but can also be provided greater than) the first voltage magnitude of the positive trigger voltage level provided by the first ESD protection clamp 12 (i.e., the positive ESD protection clamp). In this manner, while the input voltage V_{I} has the positive voltage polarity, the clamped ESD protection path 26 (i.e., the negative ESD protection path) in the second ESD protection clamp 14 (i.e., the negative ESD protection clamp) does not break down before the clamped ESD protection path 22 (i.e., positive ESD protection path) in the first ESD protection clamp 12 (i.e., the positive ESD protection clamp) is triggered. This prevents the maximum positive voltage rating of the ESD protection circuit 10 from being degraded by the in the first ESD protection clamp 12 (i.e., the positive ESD protection clamp).

Nevertheless, in this embodiment, the clamping device 48 (i.e., the negative clamping device) has a clamping device breakdown voltage level with a voltage magnitude less than the second voltage magnitude of the positive trigger voltage level of the first ESD protection clamp 12 (i.e., the positive clamping device). For example, the transistor TN in the first ESD protection clamp 14 (i.e., the negative ESD protection path) may break down when a positive voltage across the base BN and the emitter EN reaches the clamping device breakdown voltage level. Thus, in order to prevent the clamping device 28 (i.e., the negative clamping device) from breaking down before or while the clamped ESD protection path 22 (i.e., positive ESD protection path) in the second ESD protection clamp 12 (i.e., the positive ESD protection clamp) is triggered, the clamped ESD protection path 26 is configured to increase the fourth voltage magnitude of the positive clamp breakdown voltage level such that the fourth voltage magnitude is greater than the voltage magnitude of the clamping device breakdown voltage level provided by the clamping device 48 (i.e., the negative clamping device). More specifically, the clamped ESD protection path 26 includes a stack 62 (also referred to as “a second protection stack” hereinafter) of diode-configured semiconductor devices 64. Since the first ESD protection clamp 12 and the second ESD protection clamp 14 are symmetrical and in the dual-polarity ESD configuration, the second voltage magnitude of the negative trigger voltage level for triggering the second ESD protection clamp 14 (e.g., the negative ESD protection clamp) is substantially equal to the first voltage magnitude of the positive trigger voltage level for triggering the first ESD protection clamp 12 (e.g., the positive ESD protection clamp).

The stack 62 shown in FIG. 1 includes M number of diode-configured semiconductor devices 64, just like the M number of diode-configured semiconductor devices 44 of the stack 42. The diode-configured semiconductor devices 64 may be each be any type of semiconductor device capable of providing a diode-type operation. For example, the diode-configured semiconductor devices 64 may be diodes, varactors, transistors in a diode configuration, silicon rectifiers, and/or the like. In this embodiment, the diode-configured semiconductor devices 64 are diodes 66A-66M (also referred to as “second protection diodes” hereinafter). Each of the diodes 66A-66M is stacked within the clamped ESD protection path 26.

Since the stack 62 of the diode-configured semiconductor devices 64 shown in FIG. 1 is connected between the output terminal 18 and the non-inverting terminal 52 of the clamping device 48, the input voltage V_{I} biases the stack 62 of the diode-configured semiconductor devices 64. As such, there is a voltage drop across the stack 62 of the diode-configured semiconductor devices 64. With respect to the positive voltage polarity, the voltage across the stack 62 of the diode-configured semiconductor devices 64 has to reach a stack breakdown voltage magnitude in order for current to flow through the clamped ESD protection path 26. In this embodiment, when the input voltage V_{I} reaches the positive clamp breakdown voltage level, a voltage between the base BN and the emitter EN of the transistor TN reaches the clamping device breakdown voltage level provided by the clamping device 48 (i.e., the negative clamping device). Accordingly, the clamping device 48 and the clamped ESD protection path 26 break down. However, with respect to the positive voltage polarity, the voltage across the stack 62 of the diode-configured semiconductor devices 64 has to reach the stack breakdown voltage magnitude before the clamping device 48 breaks down. Accordingly, the stack 62 of the diode-configured semiconductor devices 64 in the clamped ESD protection path 26 of the second ESD protection clamp 14 increases the fourth voltage magnitude of the positive clamp breakdown voltage level so that the fourth voltage magnitude is greater than the positive trigger voltage level of the first ESD protection clamp 12. Additionally, the stack 62 of the diode-configured semiconductor devices 64 in the clamped ESD protection path 26 of the second ESD protection clamp 14 increases the fourth voltage magnitude of the positive clamp breakdown voltage level is greater than the positive trigger voltage level provided by the second ESD protection clamp 14. As such, the stack 62 of the diode-configured semiconductor devices 64 prevents the clamped ESD protection path 26 (i.e., the negative ESD protection path) of the second ESD protection clamp 14 (i.e., the negative ESD protection clamp) from breaking down before the clamped ESD protection path 22 (i.e., the positive ESD protection path) of the first ESD protection clamp 12 (i.e., the positive ESD protection clamp) is triggered. Therefore, the stack 62 of the diode-configured semiconductor devices 64 increases the maximum positive voltage rating of the ESD protection circuit 10.

In this embodiment, each of the diodes 66A-66M is a diode-configured BJT and is coupled in the clamped ESD protection path 26 so as to be forward biased when the input voltage V_{I} at the input terminal 16 has the negative voltage polarity and reverse biased when the input voltage V_{I} at the input terminal 16 has the positive voltage polarity. Thus, in order for the clamping device 48 to break down, the input voltage V_{I} at the input terminal 16 has to be high enough with the positive voltage polarity to cause each of the diodes 66A-66M to avalanche. While the diodes 66A-66M shown in FIG. 1 are diode-configured BJTs, any suitable type of diode may be used. Furthermore, in alternative embodiments, one or more of the diodes 66A-66M may be reverse biased with respect to the negative voltage polarity and forward biased with respect to the positive voltage polarity. Accordingly, the stack 62 of the diode-configured semiconductor devices 64 is configured to increase the fourth voltage magnitude of the positive clamp breakdown voltage level above the trigger voltage level of the first ESD protection clamp 12.

As mentioned above, the first ESD protection clamp 12 and the second ESD protection clamp 14 are symmetrical and are operably associated such that the first ESD protection clamp 12 and the second ESD protection clamp 14 are in the dual-polarity ESD configuration. The clamping device 28 is thus identical to the clamping device 48, except that the clamping device 28 and the clamping device 48 are connected in reverse with respect to the input terminal 16 and the output terminal 18. Also, the stack 36 (the first trigger stack) in the trigger path 20 is identical to the stack 56 (the second trigger stack) in the trigger path 24, except that the diode-configured semiconductor devices 38 in the trigger path 20 are connected in reverse to the diode-configured semiconductor devices 58 in the trigger path 24. The number N of the diode-configured semiconductor devices 38 in the trigger path 20 is the same number N as the diode-configured semiconductor devices 58 in the trigger path 24. The second voltage magnitude of the negative trigger voltage level provided by the second ESD protection clamp 14 (i.e., the negative ESD protection clamp) is thus substantially equal to the first voltage magnitude of the positive clamp breakdown voltage level provided by the first ESD protection clamp 12 (i.e., the positive ESD protection clamp). Also, the stack 42 (the first protection stack) in the clamped ESD protection path 22 is identical to the stack 62 (the second protection stack) in the clamped ESD protection path 26, except that the diode-configured semiconductor devices 44 in the clamped ESD protection path 22 are connected in reverse to the diode-configured semiconductor devices 64 in the clamped ESD protection path 26. The number M of the diode-configured semiconductor devices 44 in the clamped ESD protection path 22 is the same number M as the diode-configured semiconductor devices 64 in the clamped ESD protection path 26. Since the first ESD protection clamp 12 (i.e., the positive ESD protection clamp) and the second ESD protection clamp 14 (i.e., the positive ESD protection clamp) are in the dual-polarity ESD protection configuration, the fourth voltage magnitude of the positive clamp breakdown voltage level provided by the second ESD protection clamp 14 (i.e., the negative ESD protection clamp) is substantially equal to the third voltage magnitude of the negative clamp breakdown voltage level provided by the first ESD protection clamp 12 (i.e., the positive ESD protection clamp). Notably, the number M of the diodes 46A-46M (first protection diodes) in the first protection stack is so determined to cause the third voltage magnitude to be greater than the second voltage magnitude of the negative trigger voltage level of the second ESD protection claim 14. Likewise, the number M of the diodes 66A-66M (second protection diodes) in the second protection stack is so determined to cause the fourth voltage magnitude to be greater than the first voltage magnitude of the positive trigger voltage level of the first ESD protection claim 12.

In alternative embodiments, the first ESD protection clamp 12 (i.e., the positive ESD protection clamp) and the second ESD protection clamp 14 (i.e., the positive ESD protection clamp) may not be symmetrical. For example, the second voltage magnitude of the negative trigger voltage level provided by the second ESD protection clamp 14 (i.e., the negative ESD protection clamp) may be substantially different than the first voltage magnitude of the positive clamp breakdown voltage level provided by the first ESD protection clamp 12 (i.e., the positive ESD protection clamp). Additionally, the fourth voltage magnitude of the positive clamp breakdown voltage level provided by the second ESD protection clamp 14 (i.e., the negative ESD protection clamp) may be substantially different to the third voltage magnitude of the negative clamp breakdown voltage level provided by the first ESD protection clamp 12 (i.e., the positive ESD protection clamp). Furthermore, the diode-configured semiconductor devices 38 of the stack 36 and the diode-configured semiconductor devices 58 of the stack 56 may not be the same and/or may not be identical. Additionally, the diode-configured semiconductor devices 44 of the stack 42 and the diode-configured semiconductor devices 64 of the stack 62 may not be the same and/or may not be identical.

One of the advantages of the ESD protection circuit 10 over previously known ESD protection circuits is that the ESD protection circuit 10 can provide a higher level of ESD protection. More specifically, the positive trigger voltage level is increased above the clamped device trigger voltage level of the clamping device 28 by the trigger path 20 and the negative trigger voltage level is increased above the clamped device trigger voltage level of the clamping device 48 by the trigger path 24, as explained above. Additionally, in order to prevent premature breakdown, the clamped ESD protection path 22 increases the negative clamping breakdown voltage level above the trigger voltage of the ESD protection clamp 14 and the clamped ESD protection path 26 increases the positive clamping breakdown voltage level above the trigger voltage of the ESD protection clamp 12. The ESD protection circuit 10 provides this increased ESD protection without introducing significant distortion into the protected node of the IC. Additionally, a topology of the ESD protection circuit 10 can provide for a smaller and more straightforward solution by using the stacks 36, 42, 56, 62 to raise the positive trigger voltage level, the negative trigger voltage level, the positive clamp breakdown voltage level, and the negative clamp breakdown voltage level. Another advantage provided by the stacks 36, 42, 56, 62 is that the ESD protection circuit 10 is triggered and then snaps back to a much lower voltage, thus offering better protection. While a capacitance in the first ESD protection clamp 12 and the second ESD protection clamp 14 may be slightly higher than that of the stacks 36, 42, 56, 62, size reduction outweighs the small increase in capacitance. Furthermore, the increase in capacitance does not degrade normal RF performance. In addition to these benefits, this clamp does not significantly degrade a noise figure or the stability of protected components in the IC.

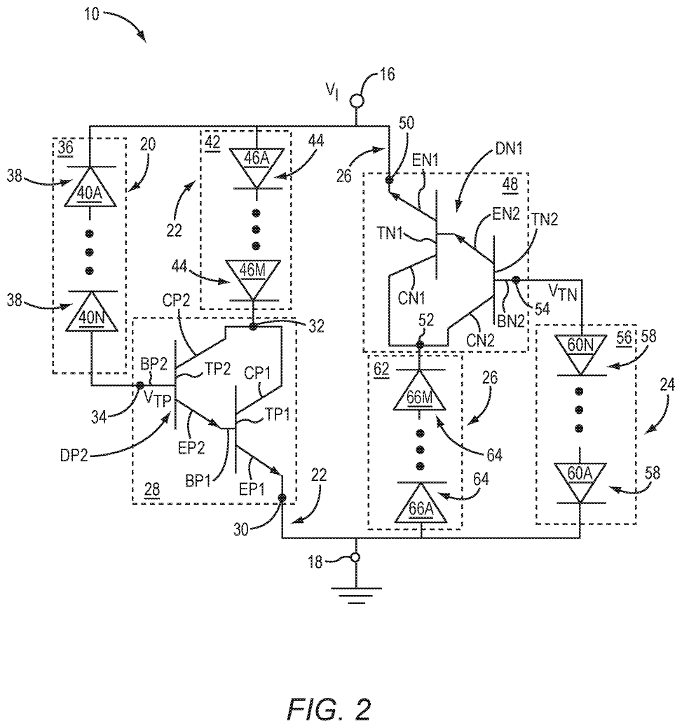

FIG. 2 illustrates another embodiment of the ESD protection circuit 10. The ESD protection circuit 10 shown in FIG. 2 is the same as the one shown in FIG. 1, except that in this embodiment, the clamping device 28 in the clamped ESD protection path 22 of the first ESD protection clamp 12 is a Darlington pair DP1 (also referred to as “a first Darlington pair” hereinafter) and the clamping device 48 in the clamped ESD protection path 26 of the second ESD protection clamp 14 is a Darlington pair DN1. With regard to the Darlington pair DP1 in the clamped ESD protection path 22 of the first ESD protection clamp 12, the Darlington pair DP1 includes a transistor TP1 (first transistor) and a transistor TP2 (also referred to as a “first paired transistor” hereinafter) (e.g., BJTs). The transistor TP1 includes a base BP1, an emitter EP1, and a collector CP1, while the transistor TP2 includes a base BP2, an emitter EP2, and a collector CP2. In this embodiment, the inverting terminal 30 (first inverting terminal) is connected to the emitter EP1 of the transistor TP1. The non-inverting terminal 32 (first non-inverting terminal) of the clamping device 28 is connected to the collector CP1 and the collector CP2. Additionally, the control terminal 34 (first control terminal) of the clamping device 28 is connected to the base BP2 of the transistor TP2.

The transistor TP1 and the transistor TP2 are coupled to form the Darlington pair DP1. Thus, the collector CP1 and the collector CP2 are connected to one another and to the non-inverting terminal 32. The base BP2 is connected to the control terminal 34 and the control terminal 34 is connected to the trigger path 20. Furthermore, the emitter EP1 is connected to the inverting terminal 30. Finally, the emitter EP2 is connected to the base BP1. The transistor TP2 is used to drive current into the base BP1 of the transistor TP1. This current is driven through the emitter EP2 of the transistor TP2 to the base BP1. By using the Darlington pair DP1, the current handling capability of the clamped ESD protection path 22 is increased relative to the clamped ESD protection path 22 shown in FIG. 1.

With regard to the Darlington pair DN1 in the clamped ESD protection path 26 of the second ESD protection clamp 14, the Darlington pair DN1 includes a transistor TN1 (second transistor) and a transistor TN2 (also referred to as “a second paired transistor” hereinafter) (e.g., BJTs). The transistor TN1 includes a base BN1, an emitter EN1, and a collector CN1, while the transistor TN2 includes a base BN2, an emitter EN2, and a collector CN2. In this embodiment, the inverting terminal 50 is connected to the emitter EN1 of the transistor TN1. The non-inverting terminal 52 of the clamping device 48 is connected to the collector CN1 and the collector CN2. Additionally, the control terminal 54 of the clamping device 48 is connected to the base BN2 of the transistor TN2.

The transistor TN1 and the transistor TN2 are coupled to form the Darlington pair DN1 (also referred to as “a second Darlington pair” hereinafter). Thus, the collector CN1 and the collector CN2 are connected to one another and to the non-inverting terminal 52 (second non-inverting terminal). The base BN2 is connected to the control terminal 54 (second control terminal) and the control terminal 54 is connected to the trigger path 24. Furthermore, the emitter EN1 is connected to the inverting terminal 50 (second inverting terminal). Finally, the emitter EN2 is connected to the base BN1. The transistor TN2 is used to drive current into the base BN1 of the transistor TN1. This current is driven through the emitter EN2 of the transistor TN2 to the base BP1. By using the Darlington pair DN1, the current handling capability of clamped ESD protection path 26 is increased relative to the clamped ESD protection path 26 shown in FIG. 1.

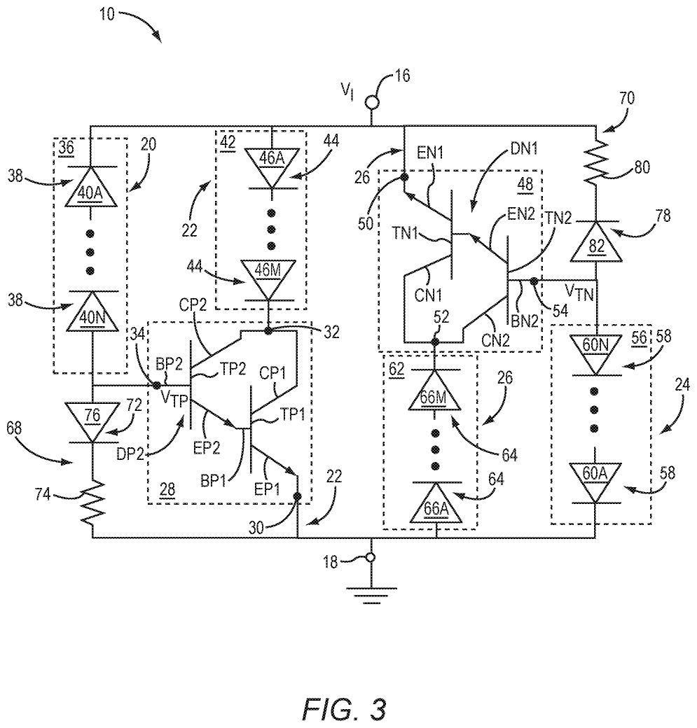

FIG. 3 illustrates another embodiment of the ESD protection circuit 10. The ESD protection circuit 10 shown in FIG. 3 is identical to the embodiment of the ESD protection circuit 10 shown in FIG. 2, except the first ESD protection clamp 12 shown in FIG. 3 includes a first trigger tuning path 68 and the second ESD protection clamp 14 shown in FIG. 3 includes a second trigger tuning path 70. The first trigger tuning path 68 is connected across the control terminal 34 and the inverting terminal 30 of the clamping device 28. The first trigger tuning path 68 is also connected to the trigger path 20. As such, the first trigger tuning path 68 is configured to be biased by the input voltage V_{I} at the input terminal 16. In this embodiment, the first trigger tuning path 68 includes a diode-configured semiconductor device 72 (also referred to as “first diode-configured semiconductor device” hereinafter) and a resistor 74 (also referred to as “a first resistor” hereinafter). The diode-configured semiconductor device 72 is a diode-configured BJT 76 that is connected within the first trigger tuning path 68. The diode-configured BJT 76 is connected within the first trigger tuning path 68 so as to be forward biased with respect to the positive voltage polarity of the input voltage V_{I} and reverse biased with respect to the negative voltage polarity of the input voltage V_{I}. Accordingly, the diode-configured BJT 76 and the resistor 74 in the first trigger tuning path 68 make it harder to drive current into the control terminal 34 of the clamping device 28. As such, the first voltage magnitude of the positive trigger voltage level provided by the first ESD protection clamp 12 shown in FIG. 3 is increased relative to the first voltage magnitude provided by the first ESD protection clamp 12 shown in FIG. 2.

With respect to the second trigger tuning path 70, the second trigger tuning path 70 is connected across the control terminal 54 and the inverting terminal 50 of the clamping device 48. The second trigger tuning path 70 is also connected to the trigger path 24. As such, the second trigger tuning path 70 is configured to be biased by the input voltage V_{I} at the input terminal 16. In this embodiment, the second trigger tuning path 70 includes a diode-configured semiconductor device 78 (also referred to as “a second diode-configured semiconductor device” hereinafter) and a resistor 80 (also referred to as “a second resistor” hereinafter). The diode-configured semiconductor device 78 is a diode-configured BJT 82 that is connected within the second trigger tuning path 70. The diode-configured BJT 82 is connected within the second trigger tuning path 70 so as to be forward biased with respect to the negative voltage polarity of the input voltage V_{I} and reverse biased with respect to the positive voltage polarity of the input voltage V_{I}. Accordingly, the diode-configured BJT 82 and the resistor 80 in the second trigger tuning path 70 make it harder to drive current into the control terminal 54 of the clamping device 48. As such, the second voltage magnitude of the negative trigger voltage level provided by the second ESD protection clamp 14 shown in FIG. 3 is increased relative to the second voltage magnitude provided by the second ESD protection clamp 14 shown in FIG. 2.

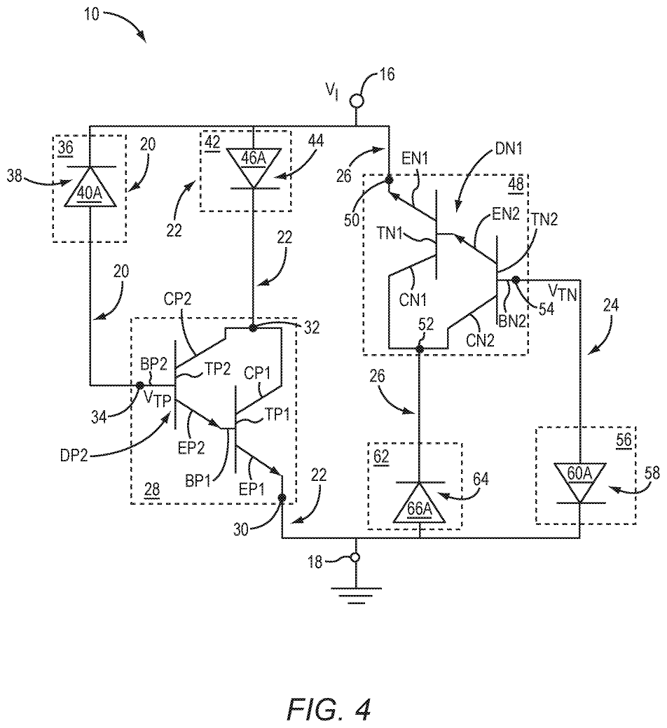

FIG. 4 illustrates another embodiment of the ESD protection circuit 10. The ESD protection circuit 10 in FIG. 4 is an example of the ESD protection circuit 10 shown in FIG. 2, where the number N of the stacks 36, 56 is equal to one (1) and the number M of the stacks 42, 62 is equal to one (1). Thus, the trigger path 20 of the first ESD protection clamp 12 only includes one diode-configured semiconductor device 38, which is the diode 40A. The trigger path 24 of the second ESD protection clamp 14 also only includes one diode-configured semiconductor device 44, which is the diode 46A. The clamped ESD protection path 22 of the first ESD protection clamp 12 only includes one diode-configured semiconductor device 58, which is the diode 60A. The clamped ESD protection path 26 of the second ESD protection clamp 14 only includes one diode-configured semiconductor device 64, which is the diode 66A.

As discussed above, each of the diodes 40A, 46A, 60A, 66A (which in this embodiment are Schottky and diode-configured BJT diodes, as discussed above) is configured to be biased by the input voltage V_{I} at the input terminal 16. When the input voltage V_{I} is applied to the input terminal 16, a voltage results across each of the diodes 40A, 46A, 60A, 66A. In this embodiment, each of the Schottky diodes 40A and 60A is configured to avalanche in response to the voltage across each of the diodes 40A and 60A reversely biasing each of the diodes 40A and 60A and having a voltage magnitude greater than or equal to 15V to 18V. Likewise, each of the diodes 46A and 66A (which are diode-configured BJTs) is configured to avalanche in response to the voltage across each of the diodes 46A and 66A having a voltage magnitude greater than or equal to 8V. Additionally, each of the diodes 40A, 46A, 60A, 66A is configured to turn on in response to the voltage across each of the diodes 40A, 46A, 60A, 66A forwardly biasing each of the diodes 40A, 46A, 60A, 66A and having the voltage magnitude greater than or equal to approximately 1.24V. Each of the threshold voltage levels of the transistors TP1, TP2, TN1, and TN2 has a base-collector forward bias voltage level of around 1.2V and a reverse bias base-emitter breakdown voltage level of approximately 8V. The ESD protection circuit 10 shown in FIG. 4 can be manufactured to have a Human Body Model (HBM) rating of between approximately 1 kV and 1.5 kV.

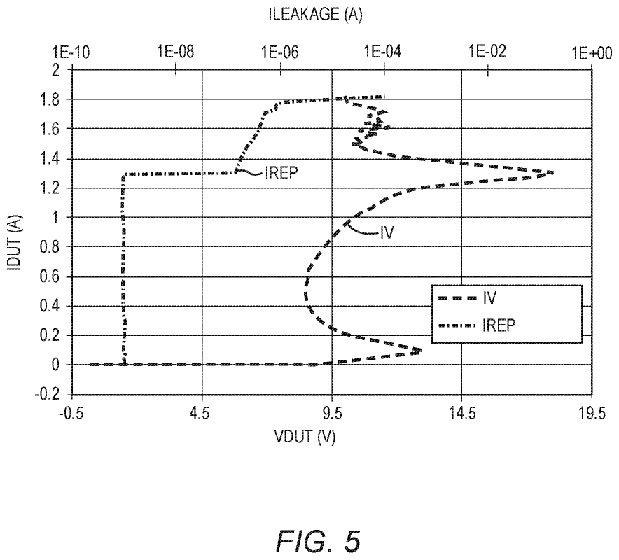

FIG. 5 is a graph that illustrates data obtained by performing Transmission Line Pulsing (TLP) testing on the ESD protection circuit 10 described above with respect to FIG. 4. A typical TLP arrangement is used to perform a TLP test on the ESD protection circuit 10 shown in FIG. 4. In the TLP test performed to obtain the data shown in FIG. 5, a pulse generator is used to transmit a sequence of 100 ns TLP pulses to the ESD protection circuit 10 described above with respect to FIG. 4. After each TLP pulse, a 1V DC leakage test is done to see if the ESD protection circuit 10 fails. As the sequence of TLP pulses progresses, a voltage magnitude of TLP pulses increases incrementally until failure is detected.

In FIG. 5, a vertical axis of the graph plots a Device Under Test (DUT) current level IDUT for the ESD protection circuit 10 shown in FIG. 4. A bottom horizontal axis of the graph plots a DUT voltage level VDUT for the ESD protection circuit 10 shown in FIG. 4. Finally, a top horizontal axis plots a leakage current level ILEAKAGE for the ESD protection circuit 10 shown in FIG. 4. A curve IV in FIG. 5 represents a relationship between the DUT current level IDUT and the DUT voltage level VDUT in accordance with data obtained as a result of the TLP test. A curve IREP in FIG. 5 represents a relationship between the leakage current level ILEAKAGE and both the DUT current level IDUT and the DUT voltage level VDUT. FIG. 5 demonstrates that the ESD protection circuit 10 shown in FIG. 4 has a nominal leakage of approximately 10 nA. At 12V, the ESD protection circuit 10 shown in FIG. 4 snaps back. This is due to the diode 40A in the trigger path 20 shown in FIG. 1 breaking down. Note that the ESD protection circuit 10 shown in FIG. 4 fails once the DUT current level IDUT reaches 1.3 A and the leakage has increased to 0.1 μA, which corresponds to the DUT voltage level VDUT of about 17.7V. At this point, the second ESD protection clamp 14 shown in FIG. 4 breaks down and the ESD protection circuit 10 fails. It has been demonstrated that the ESD protection circuit 10 shown in FIG. 4 has an HBM rating of about 450V.

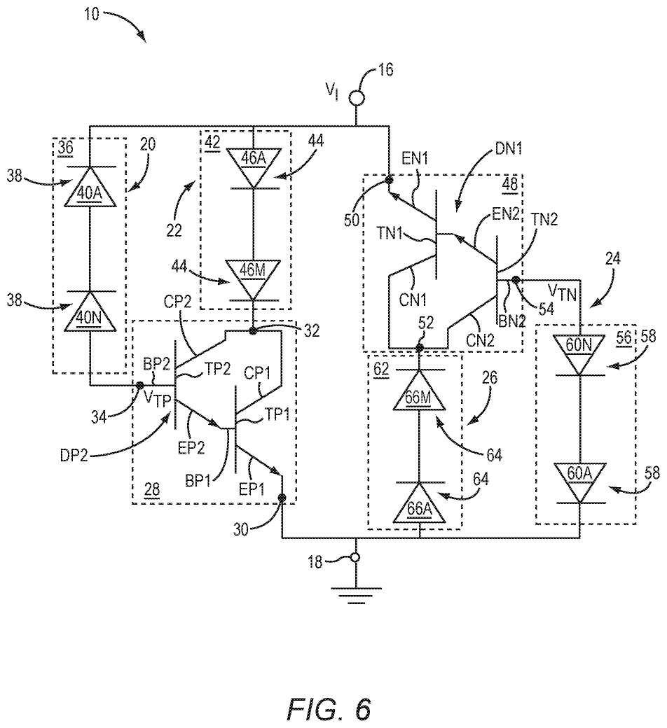

FIG. 6 illustrates another embodiment of the ESD protection circuit 10. The ESD protection circuit 10 in FIG. 6 is another example of the ESD protection circuit 10 shown in FIG. 2. In this example, the number N of the stacks 36, 56 is equal to two (2) and the number M of the stacks 42, 62 is equal to two (2). Thus, the trigger path 20 of the first ESD protection clamp 12 only includes two of the diode-configured semiconductor devices 38, which are the diodes 40A, 40N. The trigger path 24 of the second ESD protection clamp 14 also only includes two of the diode-configured semiconductor devices 44, which are the diodes 46A, 46M. The clamped ESD protection path 22 of the first ESD protection clamp 12 only includes two of the diode-configured semiconductor devices 58, which are the diodes 60A, 60N. The clamped ESD protection path 26 of the second ESD protection clamp 14 only includes two of the diode-configured semiconductor devices 64, which are the diodes 66A, 66M.

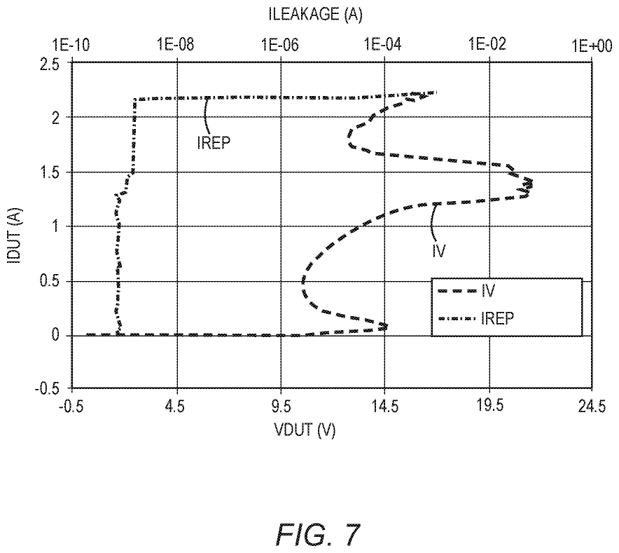

FIG. 7 is a graph that illustrates data obtained by performing a TLP test on the ESD protection circuit 10 described above with respect to FIG. 6. The TLP test is the same TLP test that was performed on the ESD protection circuit 10 shown in FIG. 4 and described with respect to FIG. 5. Thus, in FIG. 7, a vertical axis of the graph plots the DUT current level IDUT for the ESD protection circuit 10 shown in FIG. 6. A bottom horizontal axis of the graph plots the DUT voltage level VDUT for the ESD protection circuit 10 shown in FIG. 6. Finally, a top horizontal axis plots the leakage current level ILEAKAGE for the ESD protection circuit 10 shown in FIG. 6. The curve IV in FIG. 7 represents a relationship between the DUT current level IDUT and the DUT voltage level VDUT in accordance with data obtained as a result of the TLP test performed on the ESD protection clamp shown in FIG. 6. The curve IREP in FIG. 7 represents a relationship between the leakage current level ILEAKAGE with the DUT current level IDUT and the DUT voltage level VDUT in accordance with data obtained as a result of the TLP test performed on the ESD protection clamp shown in FIG. 6.

As shown in FIG. 7, the first ESD protection clamp 12 is triggered at about +14.5V and snaps back to a lower voltage level. The ESD protection circuit 10 shown in FIG. 6 operates well past 1.2 A and beyond 17V of voltage across the input terminal 16 and the output terminal 18. The second ESD protection clamp 14 breaks down at 2.3 A, which correlates to about 21V across the input terminal 16 and the output terminal 18. Hence, the ESD protection circuit 10 shown in FIG. 6 is more robust and has been shown to have an HBM rating of approximately 1500V.

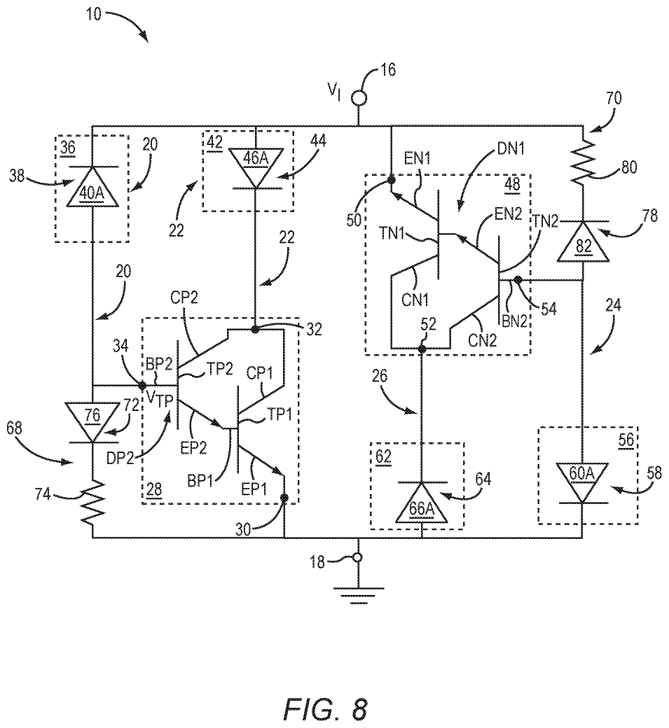

FIG. 8 illustrates another embodiment of the ESD protection circuit 10. The ESD protection circuit 10 in FIG. 8 is an example of the ESD protection circuit 10 shown in FIG. 3. More specifically, the ESD protection circuit 10 shown in FIG. 8 is the same as the ESD protection circuit 10 shown in FIG. 4 except the ESD protection circuit 10 shown in FIG. 8 further includes the first trigger tuning path 68 and the second trigger tuning path 70 described above with respect to FIG. 3. Thus, the first trigger tuning path 68 and the second trigger tuning path 70 can be used to adjust the positive trigger voltage level and the negative trigger voltage level.

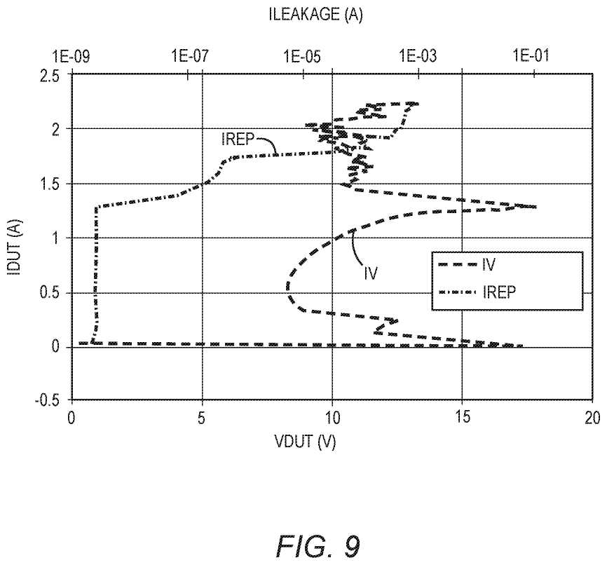

FIG. 9 is a graph that illustrates data obtained by performing a TLP test on the ESD protection circuit 10 described above with respect to FIG. 8. The TLP test is the same TLP test that was performed on the ESD protection circuit 10 shown in FIG. 4 and described with respect to FIG. 5. Thus, in FIG. 9, a vertical axis of the graph plots the DUT current level IDUT for the ESD protection circuit 10 shown in FIG. 8. A bottom horizontal axis of the graph plots the DUT voltage level VDUT for the ESD protection circuit 10 shown in FIG. 8. Finally, a top horizontal axis plots the leakage current level ILEAKAGE for the ESD protection circuit 10 shown in FIG. 8. The curve IV in FIG. 9 represents a relationship between the DUT current level IDUT and the DUT voltage level VDUT in accordance with data obtained as a result of the TLP test performed on the ESD protection circuit 10 shown in FIG. 8. The curve IREP in FIG. 9 represents a relationship between the leakage current level ILEAKAGE with the DUT current level IDUT and the DUT voltage level VDUT in accordance with data obtained as a result of the TLP test performed on the ESD protection circuit 10 shown in FIG. 8.

As shown in FIG. 9, the first ESD protection clamp 12 shown in FIG. 8 is triggered at about +17V and snaps back to a lower voltage level. The second ESD protection clamp 14 shown in FIG. 8 breaks down at 1.3 A, which correlates to about 17.8V across the input terminal 16 and the output terminal 18. Hence, the ESD protection circuit 10 shown in FIG. 8 is slightly more robust than the ESD protection circuit 10 shown in FIG. 4. Nevertheless, the HBM rating of the ESD protection circuit 10 shown in FIG. 8 is still approximately 400V.

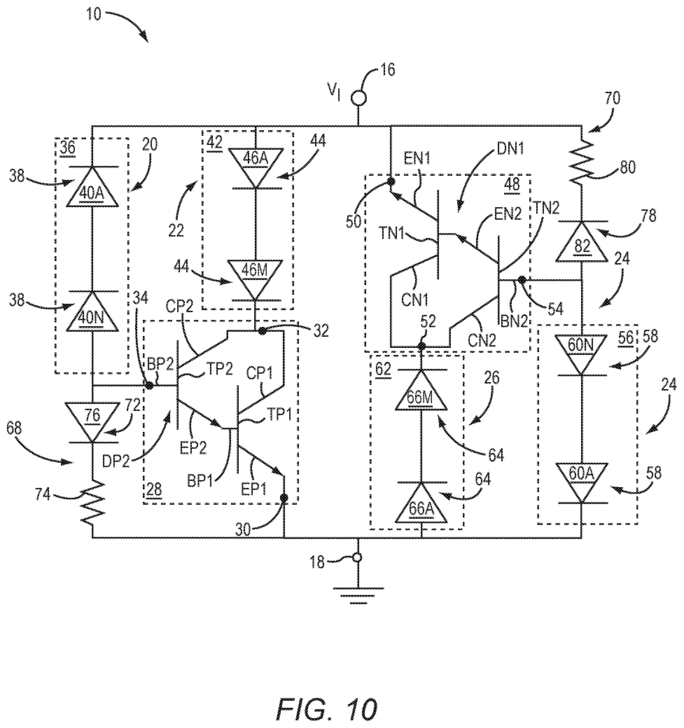

FIG. 10 illustrates another embodiment of the ESD protection circuit 10. The ESD protection circuit 10 in FIG. 10 is another example of the ESD protection circuit 10 shown in FIG. 3. More specifically, the ESD protection circuit 10 shown in FIG. 10 is the same as the ESD protection circuit 10 shown in FIG. 6 except the ESD protection circuit 10 shown in FIG. 10 further includes the first trigger tuning path 68 and the second trigger tuning path 70 described above with respect to FIG. 3. Thus, the first trigger tuning path 68 and the second trigger tuning path 70 can be used to adjust the positive trigger voltage level and the negative trigger voltage level.

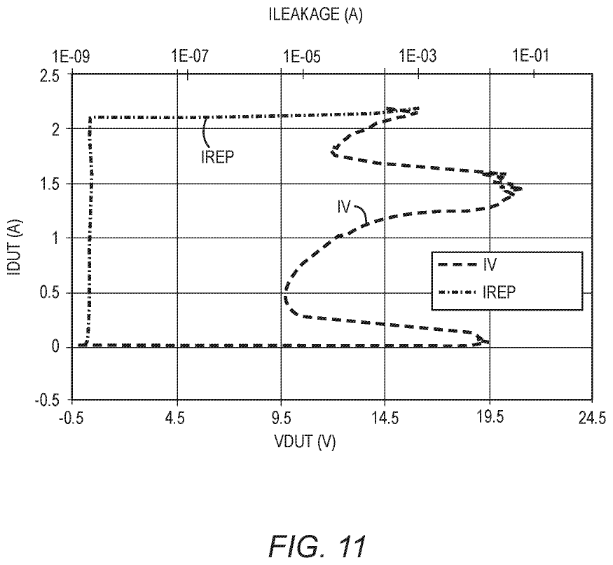

FIG. 11 is a graph that illustrates data obtained by performing a TLP test on the ESD protection circuit 10 described above with respect to FIG. 10. The TLP test is the same TLP test that was performed on the ESD protection circuit 10 shown in FIG. 4 and described above with respect to FIG. 5. Thus, in FIG. 11, a vertical axis of the graph plots the DUT current level IDUT for the ESD protection circuit 10 shown in FIG. 10. A bottom horizontal axis of the graph plots the DUT voltage level VDUT for the ESD protection circuit 10 shown in FIG. 10. Finally, a top horizontal axis plots the leakage current level ILEAKAGE for the ESD protection circuit 10 shown in FIG. 10. The curve IV in FIG. 11 represents a relationship between the DUT current level IDUT and the DUT voltage level VDUT in accordance with data obtained as a result of the TLP test performed on the ESD protection circuit 10 shown in FIG. 10. The curve IREP in FIG. 11 represents a relationship between the leakage current level ILEAKAGE with the DUT current level IDUT and the DUT voltage level VDUT in accordance with data obtained as a result of the TLP test performed on the ESD protection circuit 10 shown in FIG. 10.

The first trigger tuning path 68 and the second trigger tuning path 70 increase the positive trigger voltage level and the negative trigger voltage level, respectively. As shown in FIG. 11, the first ESD protection clamp 12 shown in FIG. 10 is triggered at about +19V and but does not snap back. The first trigger tuning path 68 thus increases the positive trigger voltage level from +14.5V (i.e., the positive trigger voltage level of the ESD protection circuit 10 shown in FIG. 6) to +19V. The second ESD protection clamp 14 shown in FIG. 10 breaks down at 2.2 A, which correlates to about +25V across the input terminal 16 and the output terminal 18. The HBM rating of the ESD protection circuit 10 shown in FIG. 10 is still approximately 1200V. Since the first trigger tuning path 68 and the second trigger tuning path 70 increase the positive trigger voltage level and the negative trigger voltage level, respectively, the ESD protection circuit 10 shown in FIG. 10 may be used in high-power applications where the RF swing on the protected node of the IC is fairly large. In particular, the ESD protection circuit 10 shown in FIG. 10 is particularly useful for providing ESD protection to antenna ports of high-power amplifiers in wireless consumer electronics, such as cellular phones or wireless Local Area Network (LAN) communication systems.

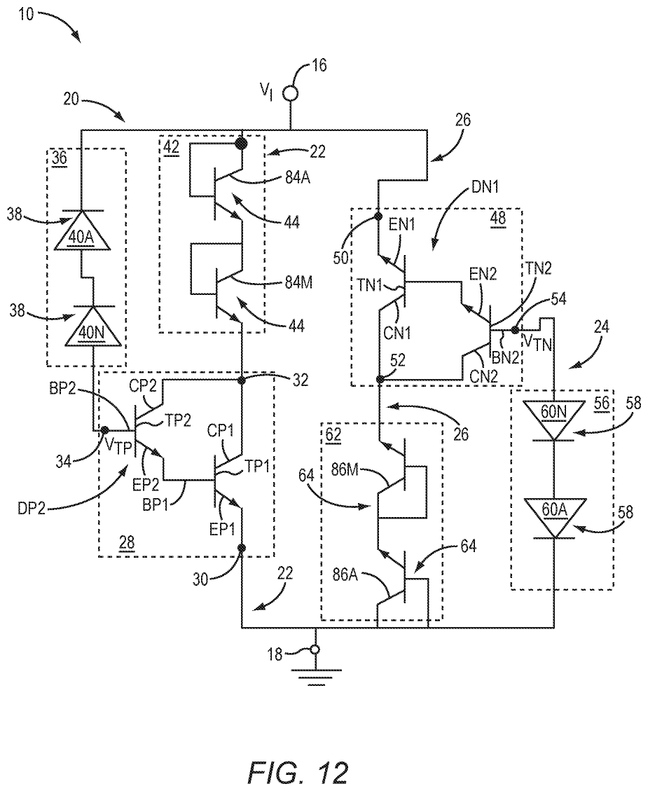

FIG. 12 illustrates another embodiment of the ESD protection circuit 10. The ESD protection circuit 10 in FIG. 12 is still another example of the ESD protection circuit 10 shown in FIG. 2. More specifically, the ESD protection circuit 10 shown in FIG. 12 is similar to the ESD protection circuit 10 shown in FIG. 6. However, in the ESD protection circuit 10 shown in FIG. 12, the diode-configured semiconductor devices 44 in the clamped ESD protection path 22 are diode-configured transistors 84A, 84M. In addition, the diode-configured semiconductor devices 64 in the clamped ESD protection path 26 shown in FIG. 12 are diode-configured transistors 86A, 86M. TLP tests on the ESD protection circuit 10 illustrated in FIG. 12 show that the ESD protection circuit 10 illustrated in FIG. 12 has characteristics similar to the ESD protection circuit 10 illustrated in FIG. 6 and described above with respect to the graph illustrated in FIG. 7. However, the diode-configured transistors 84A, 84M and the diode-configured transistors 86A, 86M allow for the ESD protection circuit 10 to handle slightly higher current levels prior to breakdown.

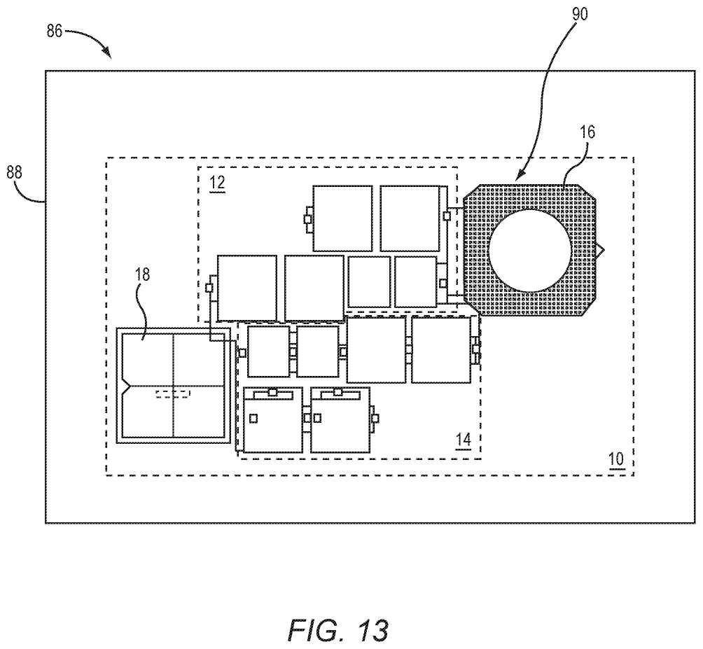

FIG. 13 illustrates an exemplary physical layout of the ESD protection circuit 10 shown in FIG. 12 having the first ESD protection clamp 12 and the second ESD protection clamp 14. The ESD protection circuit 10 shown in FIG. 13 is integrated into a semiconductor die 86. The semiconductor die 86 includes a semiconductor substrate 88 used to form active semiconductor devices. In this embodiment, the semiconductor substrate 88 is formed from Gallium Arsenide (GaAs). However, any other suitable semiconductor material may be used, such as Silicon (Si), Silicon Germanium (SiGe), Gallium Nitride (GaN), Indium Phosphorus (InP), and/or the like. Typical dopants that may be utilized to dope the semiconductor substrate 88 are Gallium (Ga), Arsenic (As), Silicon (Si), Tellurium (Te), Zinc (Zn), Sulfur (S), Boron (B), Phosphorus (P), Aluminum Gallium Arsenide (AlGaAs), Indium Gallium Arsenide (InGaAs), and/or the like. Furthermore, metallic layers may be formed on a top, within, and/or on a bottom of the semiconductor substrate 88 to provide terminals of the active semiconductor components. Insulating layers, such as oxide layers, and metal layers may also be provided in or on the semiconductor substrate 88.

The semiconductor die 86 also includes a Back End of Line (BEOL) 90, which may be formed from a non-conductive substrate and a plurality of metallic layers provided on or in the insulating substrate. The BEOL 90 is configured to couple the components on the semiconductor substrate 88 to one another. Terminals may also be provided by the BEOL 90 to provide connections to external components. In this embodiment, the input terminal 16 and the output terminal 18 are each formed as metallic pads. The BEOL 90 may also be used to form passive impedance elements. The ESD protection circuit 10 is smaller than other previously known ESD protection circuits with the same HBM rating. Due to the compactness of the ESD protection circuit 10, an IC (not shown) protected by the ESD protection circuit 10 may be formed on the same semiconductor die 86. For example, an RF power amplifier (not shown) may be formed on the semiconductor die 86 and the ESD protection circuit 10 can also be formed on the semiconductor die 86. Thus, the ESD protection circuit 10 is spatially and economically efficient, since the ESD protection circuit 10 and the protected IC do not have to be formed on separate semiconductor dies.

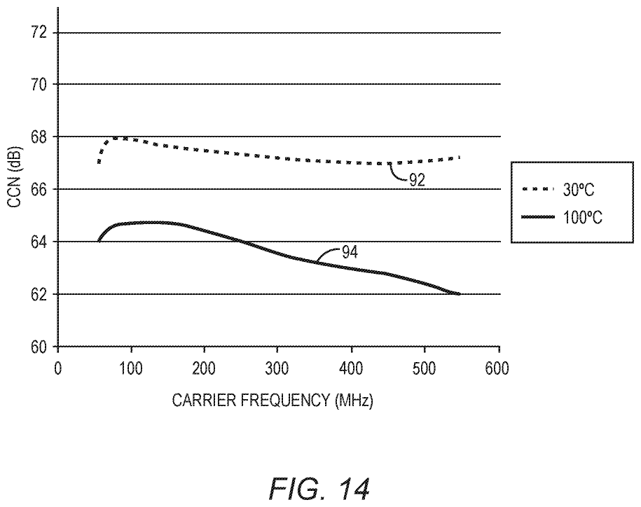

FIG. 14 illustrates a graph that describes a Carrier to Composite Noise Ratio (CCN) of an RF power amplifier having a node protected by the ESD protection circuit 10 shown in FIGS. 12 and 13. In particular, the RF power amplifier is a Cable Television (CATV) amplifier. The CCN is plotted along a vertical axis of the graph shown in FIG. 14. The CCN is plotted versus a carrier frequency of an RF signal being amplified by the CATV amplifier. The carrier frequency of the RF signal is plotted along the horizontal axis. A curve 92 illustrates a relationship between the CCN and the carrier frequency when the CATV is operating at 30 degrees Celsius. The curve 94 illustrates a relationship between the CCN and the carrier frequency when the CATV amplifier is operating at 100 degrees Celsius. The curve 92 and the curve 94 demonstrate that the ESD protection circuit 10 does not introduce significant distortion and that the CATV amplifier maintains high linearity through temperature variations.

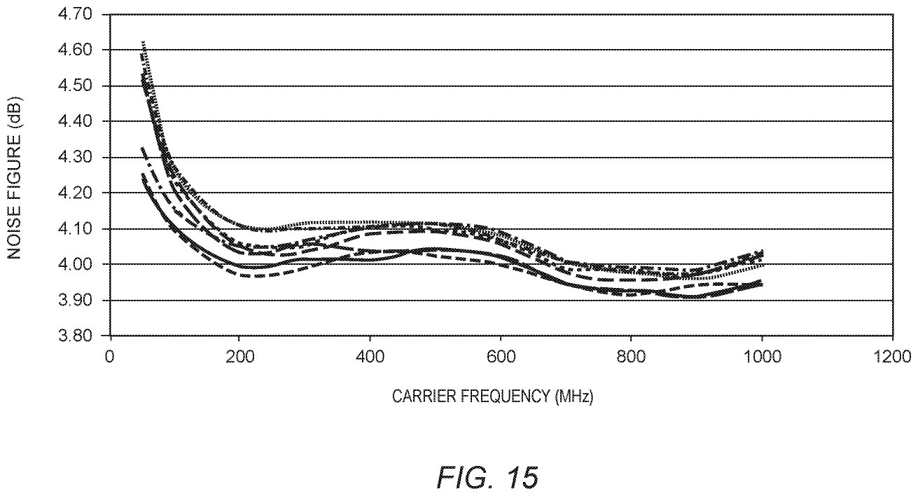

FIG. 15 is a graph that illustrates a noise figure of the CATV amplifier that uses the ESD protection circuit 10 shown in FIGS. 12 and 13. The noise figure is plotted along the vertical axis and is described versus a carrier frequency of an RF signal being amplified by the CATV amplifier. The carrier frequency of the RF signal is plotted along the horizontal axis. The various curves shown in FIG. 15 each illustrate a relationship between the noise figure and the carrier frequency for different noise temperatures. As shown by the curves illustrated by the graph in FIG. 15, there is little to no degradation in the noise figure when the ESD protection circuit 10 shown in FIGS. 12 and 13 is used to provide ESD protection to the CATV amplifier.

Those skilled in the art will recognize improvements and modifications to the preferred embodiments of the present disclosure. All such improvements and modifications are considered within the scope of the concepts disclosed herein and the claims that follow.

What is claimed is:

1. An electrostatic discharge (ESD) protection circuit comprising:
a first ESD protection clamp coupled between an input terminal and an output terminal and comprising:
a first clamped ESD protection path comprising a first protection stack and a first clamping device; and
a first trigger path comprising a first trigger stack configured to trigger the first clamped ESD protection path in response to an input voltage between the input terminal and the output terminal reaching a first trigger voltage level, the first trigger voltage level being defined by a first voltage polarity and a first voltage magnitude; and
a second ESD protection clamp coupled between the input terminal and the output terminal and comprising:
a second clamped ESD protection path comprising a second protection stack identical to the first protection stack and a second clamping device identical to the first clamping device; and
a second trigger path comprising a second trigger stack identical to the first trigger stack and configured to trigger the second clamped ESD protection path in response to the input voltage between the input terminal and the output terminal reaching a second trigger voltage level, the second trigger voltage level being defined by a second voltage polarity antipodal to the first voltage polarity and a second voltage magnitude substantially equal the first voltage magnitude.

2. The ESD protection circuit of claim 1 wherein:
the first clamping device is configured to clamp the first clamped ESD protection path in response to the input voltage that biases the first trigger path reaching the first trigger voltage level such that the first clamped ESD protection path is triggered as a result of the first clamping device being triggered; and
the second clamping device is configured to clamp the second clamped ESD protection path in response to the input voltage that biases the second trigger path reaching the second trigger voltage level such that the second clamped ESD protection path is triggered as a result of the second clamping device being triggered.

3. The ESD protection circuit of claim 1 wherein
the first clamped ESD protection path is configured to break down in response to the input voltage reaching a first clamp breakdown voltage level defined by the second voltage polarity and a third voltage magnitude greater than the second voltage magnitude; and
the second clamped ESD protection path is configured to break down in response to the input voltage reaching a second clamp breakdown voltage level defined by the first voltage polarity and a fourth voltage magnitude greater than the first voltage magnitude.

4. The ESD protection circuit of claim 3 wherein the third voltage magnitude is substantially equal to the fourth voltage magnitude.

5. The ESD protection circuit of claim 3 wherein:
the first protection stack comprises a plurality of first protection diodes configured to cause the third voltage magnitude to be greater than the second voltage magnitude; and
the second protection stack comprises a plurality of second protection diodes configured to cause the fourth voltage magnitude to be greater than the first voltage magnitude.

6. The ESD protection circuit of claim 5 wherein a number of the plurality of first protection diodes equals a number of the plurality of second protection diodes.

7. The ESD protection circuit of claim 1 wherein:
the first trigger stack comprises a plurality of first trigger diodes; and
the second trigger stack comprises a plurality of second trigger diodes.

8. The ESD protection circuit of claim 7 wherein a number of the plurality of first trigger diodes equals a number of the plurality of second trigger diodes.

9. The ESD protection circuit of claim 7 wherein:
each of the plurality of first trigger diodes is configured to avalanche to trigger the first clamped ESD protection path in response to the input voltage of the first voltage polarity reaching the first voltage magnitude; and
each of the plurality of second trigger diodes is configured to avalanche to trigger the second clamped ESD protection path in response to the input voltage of the second voltage polarity reaching the second voltage magnitude.

10. The ESD protection circuit of claim 7 wherein:
each of the plurality of first trigger diodes is coupled so as to be reverse biased with respect to the first voltage polarity; and
each of the plurality of second trigger diodes is coupled so as to be reverse biased with respect to the second voltage polarity.

11. The ESD protection circuit of claim 1 wherein:
the first clamping device comprises a first transistor having a first inverting terminal coupled within the first clamped ESD protection path, a first non-inverting terminal coupled within the first clamped ESD protection path, and a first control terminal coupled to the first trigger path; and
the second clamping device comprises a second transistor having a second inverting terminal coupled within the second clamped ESD protection path, a second non-inverting terminal coupled within the second clamped ESD protection path, and a second control terminal coupled to the first trigger path.

12. The ESD protection circuit of claim 11 further comprising:
a first trigger tuning path coupled between the first control terminal and the first inverting terminal; and
a second trigger tuning path coupled between the second control terminal and the second inverting terminal.

13. The ESD protection circuit of claim 12 wherein:
the first trigger tuning path comprises:
a first diode-configured semiconductor device coupled to the first control terminal; and
a first resistor coupled between the first diode-configured semiconductor device and the first inverting terminal; and
the second trigger tuning path comprises:
a second diode-configured semiconductor device coupled to the second control terminal; and
a second resistor coupled between the second diode-configured semiconductor device and the second inverting terminal.

14. The ESD protection circuit of claim 1 wherein:
the first clamping device comprises a first transistor and a first paired transistor, wherein the first transistor and the first paired transistor are coupled as a first Darlington pair, the first Darlington pair having a first inverting terminal coupled within the first clamped ESD protection path, a first non-inverting terminal coupled within the first clamped ESD protection path, and a first control terminal coupled to the first trigger path; and
the second clamping device comprises a second transistor and a second paired transistor, wherein the second transistor and the second paired transistor are coupled as a second Darlington pair, the second Darlington pair having a second inverting terminal coupled within the second clamped ESD protection path, a second non-inverting terminal coupled within the second clamped ESD protection path, and a second control terminal coupled to the second trigger path.

15. The ESD protection circuit of claim 14 further comprising:
a first trigger tuning path coupled between the first control terminal and the first inverting terminal; and
a second trigger tuning path coupled between the second control terminal and the second inverting terminal.

16. The ESD protection circuit of claim 15 wherein:
the first trigger tuning path comprises:
a first diode-configured semiconductor device coupled to the first control terminal; and
a first resistor coupled between the first diode-configured semiconductor device and the first inverting terminal; and
the second trigger tuning path comprises:
a second diode-configured semiconductor device coupled to the second control terminal; and
a second resistor coupled between the second diode-configured semiconductor device and the second inverting terminal.

17. The ESD protection circuit of claim 1 wherein:
the first trigger stack comprises only one first trigger diode;
the first protection stack comprises only one first protection diode;
the second trigger stack comprises only one second trigger diode; and
the second protection stack comprises only one second protection diode.

18. The ESD protection circuit of claim 17 wherein:
the first clamping device comprises a first transistor and a first paired transistor, wherein the first transistor and the first paired transistor are coupled as a first Darlington pair, the first Darlington pair having a first inverting terminal coupled within the first clamped ESD protection path, a first non-inverting terminal coupled within the first clamped ESD protection path, and a first control terminal coupled to the first trigger path; and
the second clamping device comprises a second transistor and a second paired transistor, wherein the second transistor and the second paired transistor are coupled as a second Darlington pair, the second Darlington pair having a second inverting terminal coupled within the second clamped ESD protection path, a second non-inverting terminal coupled within the second clamped ESD protection path, and a second control terminal coupled to the second trigger path.

19. The ESD protection circuit of claim 18 further comprising:
a first trigger tuning path coupled between the first control terminal and the first inverting terminal; and
a second trigger tuning path coupled between the second control terminal and the second inverting terminal.

20. The ESD protection circuit of claim 19 wherein:
the first trigger tuning path comprises:
a first diode-configured semiconductor device coupled to the first control terminal; and
a first resistor coupled between the first diode-configured semiconductor device and the first inverting terminal; and
the second trigger tuning path comprises:
a second diode-configured semiconductor device coupled to the second control terminal; and
a second resistor coupled between the second diode-configured semiconductor device and the second inverting terminal.
